(19) United States
(12) Patent Application Publication
(10) Pub. No.: US 2013/0077547 A1
(43) Pub. Date: Mar. 28, 2013

(54) MOBILE STATION, CONTROL METHOD AND COMMUNICATION SYSTEM

(71) Applicant: Takeshi KODAMA, Yokohama (JP)

(72) Inventor: Takeshi KODAMA, Yokohama (JP)

(73) Assignee: FUJITSU LIMITED, Kawasaki-shi (JP)

(21) Appl. No.: 13/558,621

(22) Filed: Jul. 26, 2012

(30) Foreign Application Priority Data
Sep. 22, 2011 (JP) 2011-208188

(51) Int. Cl. H04W 52/02

(52) U.S. Cl. 370/311

(57) ABSTRACT

A mobile station includes a communication section that enters an active state at call timings for calls from a base station, receives a communication parameter transmitted at transmission timings from the base station, and uses the received communication parameter to conduct data communication with the base station, a judging section that judges, when an update of the communication parameter is detected, whether the communication parameter is able to be received in the active state at a next call timing for a next call from the base station based on the transmission timings, and a controller that, when the judging section judges that the communication parameter is able to be received, causes the communication section to enter an idle state until the next call timing.

### CROSS-REFERENCE TO RELATED APPLICATION

This application is based upon and claims the benefit of priority of the prior Japanese Patent Application No. 2011-208188, filed on Sep. 22, 2011, the entire contents of which is incorporated herein by reference.

### FIELD

Embodiments discussed herein relate to a mobile station, a control method, and a communication system.

### BACKGROUND

Conventionally, a wireless communication system includes a base station (BS) that provides a wireless communication area, and a mobile station (MS). One example of a wide area wireless communication system is the mobile worldwide interoperability for microwave access (WiMAX) standard prescribed in IEEE 802.16e.

Power consumption performance (for example, consecutive operating timing) is a major factor for a mobile station in a wireless communication system since the mobile station uses a battery and the like for operation. Consequently, mobile stations are operated intermittently to reduce power consumption during waiting timings. Intermittent operation includes periodically turning on (awake state) the power of sections of the circuits of the mobile station in synch with a periodic call (paging) from the base station to receive the call, and turning the power of the circuits off (sleep state) outside of the timing for the periodic call.

However, in for example Japanese National Publication of International Patent Application No. 2008-515333, common settings in mobile stations and base stations are applied to parameters used in communication systems such as a modulation system or an encoding system to allow the mobile station and the base station to conduct data communication.

### SUMMARY

According to an aspect of the embodiments, a mobile station includes a communication section that enters an active state at call timings for calls from a base station, receives a communication parameter transmitted at transmission timings from the base station, and uses the received communication parameter to conduct data communication with the base station, a judging section that judges, when an update of the communication parameter is detected, whether the communication parameter is able to be received in the active state at a next call timing for a next call from the base station based on the transmission timings, and a controller that, when the judging section judges that the communication parameter is able to be received, causes the communication section to enter an idle state until the next call timing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a communication system and a mobile station according to a first embodiment;

FIG. 2 describes an example of a hardware configuration of the mobile station;

FIG. 3 illustrates an example of intermittent operation by the mobile station;

FIG. 4 illustrates an example of a DCD message reception operation by the mobile station;

FIG. 5 is an example of a DL-MAP format;

FIG. 6 is an example of a BCCP_IE format;

FIG. 7 is an example of a DCD message format;

FIG. 8A is an example of a DREG-CMD message format;

FIG. 8B is an example of a TLV Encoded Information format;

FIG. 9A is a first flow chart illustrating an example of operations by the mobile station according to the first embodiment;

FIG. 9B is a second flow chart illustrating an example of operations by the mobile station according to the first embodiment;

FIG. 10 illustrates an example of overhead when switching to an awake state;

FIG. 11 illustrates an example of a DCD message reception operation according to a second embodiment;

FIG. 12A is a first flow chart illustrating an example of operations by the mobile station according to the second embodiment;

FIG. 12B is a second flow chart illustrating an example of operations by the mobile station according to the second embodiment;

FIG. 13 illustrates an example of a DCD message reception operation according to a third embodiment;

FIG. 14A is a first flow chart illustrating an example of operations by the mobile station according to the third embodiment;

FIG. 14B is a second flow chart illustrating an example of operations by the mobile station according to the third embodiment;

FIG. 15 illustrates an example of a DCD message reception operation according to a fourth embodiment;

FIG. 16A is a first flow chart illustrating an example of operations by the mobile station according to the fourth embodiment; and

FIG. 16B is a second flow chart illustrating an example of operations by the mobile station according to the fourth embodiment.

### DESCRIPTION OF EMBODIMENTS

Detailed explanations of embodiments of the mobile station, the control method, and the communication system described hereinbelow will be provided with reference to the accompanying drawings.

While inventing the present embodiments, observations were made regarding a related art. Such observations include the following, for example.

In a communication system of a related art, common settings in mobile stations and base stations are applied to parameters used in communication systems such as a modulation system or an encoding system to allow the mobile station and the base station to conduct data communication. In mobile WiMAX for example, the base station includes the communication parameters in a control message called a DCD/UCD (downlink channel descriptor/uplink channel descriptor) message and regularly broadcasts the message to the mobile station.

The DCD/UCD message is broadcasted even when the communication parameters are not changed. The mobile station receives the DCD/UCD message and applies the communication parameters included in the received DCD/UCD message. The mobile station receives, for example, the DCD/UCD message without omission since the timing in which the contents of the communication parameters are changed is unknown.

The mobile station is not able to receive the DCD/UCD message when the DCD/UCD message is transmitted from the base station while the mobile station is in a sleep state due to the intermittent operation. As a result, the mobile station is not able to realize a change in the communication parameters in real timing if a new value of a changed communication parameter is included in a DCD/UCD message that is not received by the mobile station.

As a result, when data communication is being conducted between the mobile station and the base station, the mobile station may not be able to decode data addressed to itself or transmit data since the communication parameters have been changed. Consequently, switching the mobile station to an awake state when the mobile station is in the sleep state to receive communication parameters when such parameters are updated is prescribed in mobile WiMAX.

However, the abovementioned technology of the related art has a problem in that the timing of the awake state becomes longer and causes an increase in power consumption in the mobile station.

### First Embodiment

### Communication System and Mobile Station

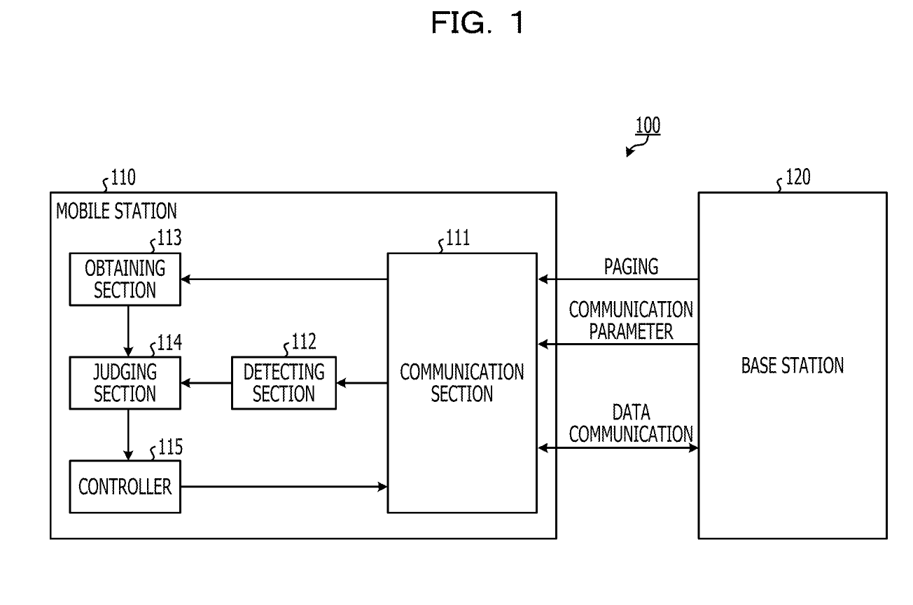

FIG. 1 illustrates an example of a communication system and a mobile station according to a first embodiment. As illustrated in FIG. 1, a communication system 100 according to the first embodiment includes a mobile station 110 and a base station 120. Mobile WiMAX may be applied, for example, as a communication protocol of the communication system 100. However, other communication protocols besides mobile WiMAX may also be used in the communication system 100. The mobile station 110 is located in the area of the base station 120 and the mobile station 110 is a wireless communication device that conducts wireless communication with the base station 120.

The base station 120 periodically conducts calling (paging) to nearby mobile stations such as the mobile station 110. In addition, the base station 120 periodically (for example, in 1-second cycles) transmits a communication parameter related to data communication conducted between the base station 120 and nearby mobile stations such as the mobile station 110. A communication parameter represents information that indicates a communication method such as a modulation method or an encoding method. For example, the base station 120 conducts the transmission of calls and transmission of the communication parameter in different cycles.

The following is a detailed explanation of a configuration of the mobile station 110. The mobile station 110 includes, for example, a communication section 111, a detecting section 112, an obtaining section 113, a judging section 114, and a controller 115.

Communication Section

The communication section 111 enters an active state (awake state) or an idle state (sleep state) according to control conducted by, for example, the controller 115. The active state is a state, for example, in which the supply of power to the communication section 111 is on. The idle state is a state, for example, in which the supply of power to the communication section 111 is off. Therefore, the power consumption of the mobile station 110 increases when the communication section 111 is in the active state, and the power consumption of the mobile station 110 decreases when the communication section 111 is in the idle state.

The communication section 111 enters the active state at the timing for a periodic call made by the base station 120 only for a specific period of timing, and replies when a call and the like addressed to the mobile station 110 occurs. The communication section 111 receives, during the active state, the communication parameter transmitted from the base station 120, and conducts data communication with the base station 120 using the received communication parameter. Data communication may include, for example, voice communication and the like.

During the active state, the communication section 111 may also receive from the base station 120 version number information that indicates a version number of the communication parameter currently being transmitted by the base station 120. The communication section 111 outputs the received version number information to the detecting section 112.

During the active state, the communication section 111 may also receive, from the base station 120, timing information that indicates the next transmission timing for the communication parameter transmitted by the base station 120. The communication section 111 outputs the received timing information to the obtaining section 113.

Detecting Section

The detecting section 112 detects whether the communication parameter transmitted from the base station 120 has been updated. For example, the detecting section 112 detects that the communication parameter transmitted from the base station 120 has been updated based on the version number information output by the communication section 111. Specifically, the detecting section 112 stores version number information output by the communication section 111.

The detecting section 112 detects that the communication parameter has been updated by determining whether the version number information next output by the communication section 111 has changed from the previously stored version number information. When it is determined that the communication parameter has been updated, the detecting section 112 outputs an update signal indicating that the communication parameter has been updated to the judging section 114.

Obtaining Section

The obtaining section 113 obtains the timing for transmission of the communication parameter from the base station 120. For example, a transmission cycle of the communication parameter from the base station 120 is stored in a memory of the mobile station 110. The obtaining section 113 derives each timing for transmission of the communication parameter from a calculation based on the timing information output from the communication section 111 and the transmission cycle stored in the memory.

The following is an explanation of a method of obtaining the communication parameter transmission cycle stored in the memory of the mobile station 110. For example, before the update of the communication parameter is detected by the detecting section 112 (when, for example, connected to the base station 120), the communication section 111 is in the awake state until a plurality of communication parameters consecutively transmitted by the base station 120 is received.

The obtaining section 113 obtains the communication parameter transmission cycle from calculations based on each timing for the communication parameters that are received from the communication section 111 a plurality of timings. The obtained transmission cycle is stored in a memory of the mobile station 110. For example, when communication parameters are received twice consecutively from the communication section 111, the obtaining section 113 derives the cycle of the communication parameters by calculating an interval between when the communication parameters were received.

The obtaining section 113 may also obtain the communication parameter transmission cycle when update signals are output by the detecting section 112. The obtaining section 113 may also obtain, through the communication section 111 and from the base station 120 and the like, information indicating timings for transmission of the communication parameter transmitted from the base station 120. The obtaining section 113 outputs the obtained transmission timings to the judging section 114.

Judging Section

When an update signal is output by the detecting section 112, the judging section 114 judges whether the communication section 111 is able to receive the communication parameter in a period when the communication section 111 is in an active state at the next call timing from the base station 120. Specifically, the judging section 114 judges whether the next call timing approximately matches a transmission timing of the communication parameter based on the transmission timings output by the obtaining section 113.

The judging section 114 outputs the judging result to the controller 115. When the mobile station 110 connects to the base station 120, the base station notifies the mobile station 110 about the timing of calls from the base station 120, and the notified call timing is stored in a memory of the mobile station 110.

Controller

When the judging result from the judging section 114 indicates that, in a period in which the communication section 111 is in the active state at the next call timing, a communication parameter may be received, the controller 115 switches the communication section 111 to the idle state until the next call timing. In this case, the controller 115 causes the communication section 111 to be switched to the active state at the next call timing without causing the communication section 111 to switch to the active state until the next call timing even if there is a timing when a communication parameter is transmitted. As a result, the most recent communication parameter may be received at the next call timing.

When the judging result output by the judging section 114 indicates that, in a period in which the communication section 111 is in the active state at the next call timing, the communication parameter is not able to be received, the controller 115 causes the communication section 111 to switch to the active state at the next call timing. As a result, the most recent communication parameter may be received at the timing of the next call of the communication parameter from the base station 120.

The judging section 114 may start judging at a timing different from the timing in which the detecting section 112 detects that the communication parameter has been updated. In this case, the detecting section 112 may be omitted from the configuration of the mobile station 110.

Hardware Configuration of Mobile Station

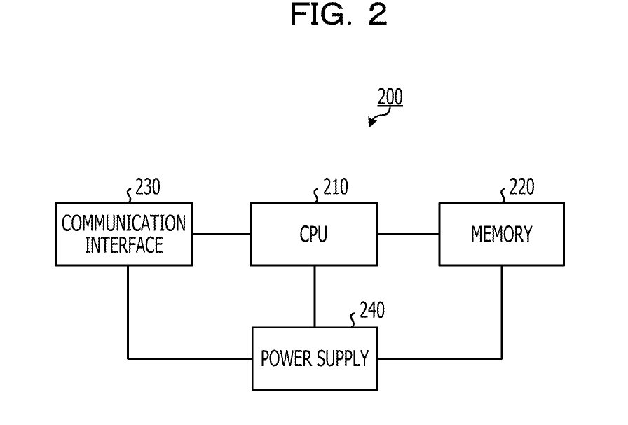

FIG. 2 describes a hardware configuration of the mobile station. The mobile station 110 illustrated in FIG. 1 may be achieved by, for example, an information processor apparatus 200 illustrated in FIG. 2. The information processor apparatus 200 includes a central processing unit (CPU) 210, a memory 220, a communication interface 230, and a power supply 240.

The CPU 210, the memory 220, and the communication interface 230 are interconnected, for example, by a bus. The CPU 210, the memory 220, and the communication interface 230 operate with power provided by the power supply 240.

The CPU 210 controls the entire information processor apparatus 200. The information processor apparatus 200 may include a plurality of CPUs 210. The memory 220 has a main memory realized, for example, by a random access memory (RAM). The main memory is used as a work area by the CPU 210. The memory 220 may also include an auxiliary memory implemented by a non-volatile memory such as a hard disc or a flash memory and the like. Various types of programs that actuate the information processor apparatus 200 are stored in the auxiliary memory. The programs stored in the auxiliary memory are loaded into the main memory and executed by the CPU 210.

The communication interface 230 is a communication interface that conducts, for example, wireless communication with devices (for example, the base station 120) outside of the information processor apparatus 200. The communication interface 230 is controlled by the CPU 210. The power supply 240 provides a power source to the CPU 210, the memory 220, and the communication interface 230. The power supply 240 is controlled by the CPU 210.

For example, the CPU 210 causes the communication interface 230 to switch to an awake state by controlling the power supply 240 to turn on the power source provided to the communication interface 230. The CPU 210 causes the communication interface 230 to switch to a sleep state by controlling the power supply 240 to turn off the power source provided to the communication interface 230.

The information processor apparatus 200 may also include an input device to receive input operations from a user, and a user interface that includes an output device and the like to output information to the user. The input device may be realized by, for example, keys (such as a keyboard and the like). The output device may be realized by, for example, a display and/or a speaker. The input device and the output device may be realized by a touch panel and the like. The user interface is controlled by the CPU 210.

The communication section 111 illustrated in FIG. 1 may be realized by, for example, the communication interface 230. The obtaining section 113, the detecting section 112, the judging section 114, and the controller 115 illustrated in FIG. 1 may be realized, for example, by the CPU 210 and the memory 220.

Intermittent Operation by the Mobile Station

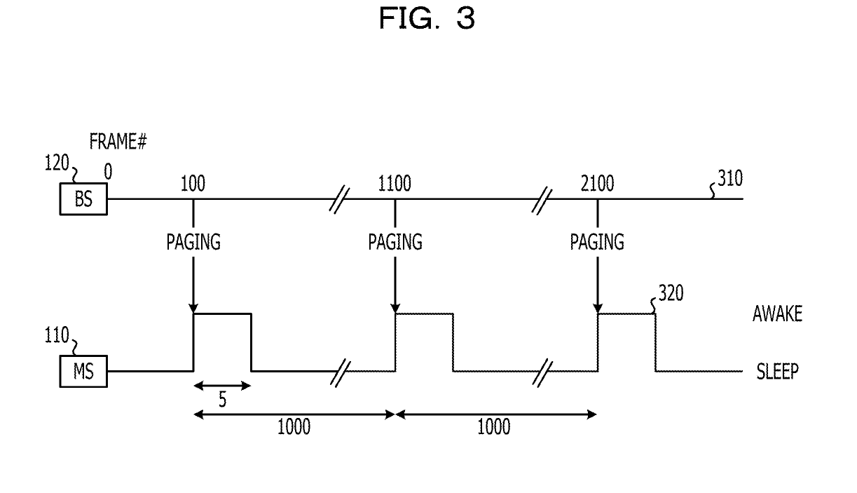

FIG. 3 illustrates an example of intermittent operation by the mobile station. The horizontal axis in FIG. 3 indicates timing according to frame numbers (frame #). A paging timing 310 indicates when paging by the base station 120 (BS 120) occurs. A terminal state 320 indicates a change between an awake state (awake) and a sleep state (sleep) of the communication section 111 in the mobile station 110 (MS 110).

As illustrated by the paging timing 310, the base station 120 periodically conducts paging (herein, with a cycle of 1000 frames) to nearby mobile stations such as the mobile station 110. In the example illustrated in FIG. 3, the base station 120 conducts paging at timings according to frame numbers 100, 1100, 1200, and so on.

As illustrated by the terminal state 320, the mobile station 110 causes the communication section 111 to switch to the awake state in synch with the timing for the paging from the base station 120, and then causes the communication section 111 to return to the sleep state after a certain period of timing (in this case, 5 frames). The mobile station 110 receives downlink-mapping (DL-MAP) messages transmitted from the base station 120 while the mobile station 110 is in the awake state.

Below is an explanation of receiving a DCD message that includes the communication parameter for downlink data communication from the mobile station 110 to the base station 120. Receiving a UCD message that includes the communication parameter for uplink data communication from base station 120 to the mobile station 110 is conducted in a similar way.

DCD Message Reception Operation by Mobile Station

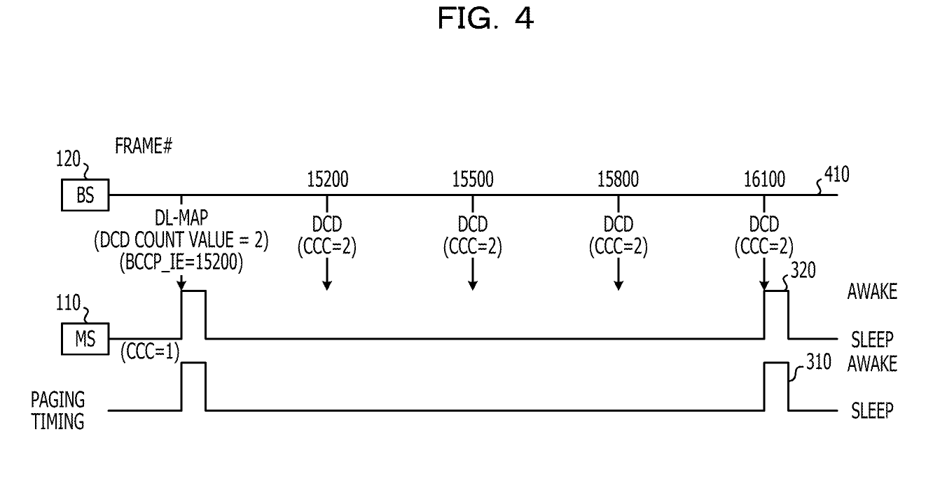

FIG. 4 illustrates an operation by the mobile station to receive a DCD message. In FIG. 4, portions similar to those illustrated in FIG. 3 are denoted by the same reference symbols and the description thereof is omitted. A DCD transmission timing 410 represents when DCD messages are transmitted by the base station 120. A DCD message includes the communication parameter for downlink data communication from the mobile station 110 to the base station 120.

As illustrated by the DCD transmission timing 410, the base station 120 periodically transmits (herein, a cycle of 300 frames) DCD messages to nearby mobile stations such as the mobile station 110. As illustrated in FIG. 4, the base station 120 transmits DCD messages at transmission timings “15200,” “15500,” “15800,” “16100,” and the like.

Herein, it is assumed that the mobile station 110 receives a DCD message at least once from the base station 120. The mobile station 110 stores a configuration change count (CCC) that is included in the latest received DCD message. The CCC is information that indicates a version number of the DCD message. The mobile station 110 sets CCC to 1 at a timing t1 that is before the transmission timing 15200.

The base station 120 conducts paging at the timing t1 and the mobile station 110 causes the communication section 111 to enter the awake state. The communication section 111 of the mobile station 110 receives, upon entering the awake state, a DL-MAP continuously (in short cycles) transmitted by the base station 120.

The DL-MAP received by the mobile station 110 at the timing t1 includes a DCD count value of “2” and a BCCP_IE equal to “15200.” The DCD count value is version number information that indicates a version number of the DCD message currently received from the base station 120. The broadcast control pointer_IE (BCCP_IE) is timing information that indicates the next transmission timing for a DCD message.

The mobile station 110 determines that the DCD message has been updated since the CCC stored by the mobile station 110 is “1” and the DCD count value of the DL-MAP is “2,” and thus do not match. The mobile station 110 stores the transmission cycle (a 300-frame cycle) of the DCD messages transmitted by the base station 120. The DCD message transmission cycle may be derived based on an interval between received DCD messages when, for example, the mobile station 110 receives the DCD messages from the base station 120 a plurality of timings.

The mobile station 110 calculates subsequent DCD message transmission timings “15200,” “15500,” “15800,” “16100” and so on based on the BCCP_IE being equal to “2” and on the 300-frame transmission cycle of the DCD messages. Specifically, the mobile station 110 may calculate the timing of the transmission of the DCD messages from the formula 15200+300×k (k=0, 1, 2, . . . ).

The mobile station 110 maintains the communication section 111 in the sleep state until the DCD message timing “16100” since the calculated DCD message transmission timing “16100” matches the next paging timing “16100.” Namely, the mobile station 110 does not cause the communication section 111 to switch to the awake state at the DCD message transmission timings “15200”, “15500”, and “15800” that are before the timing “16100”.

The mobile station 110 is able to receive both the DCD message and the paging by causing the communication section 111 to switch to the awake state at the timing “16100.” As a result, the awake timing may be shortened and power consumption may be reduced in comparison, for example, to causing the communication section 111 to switch to the awake state at the timing “15200” to receive the DCD message.

Information Formats

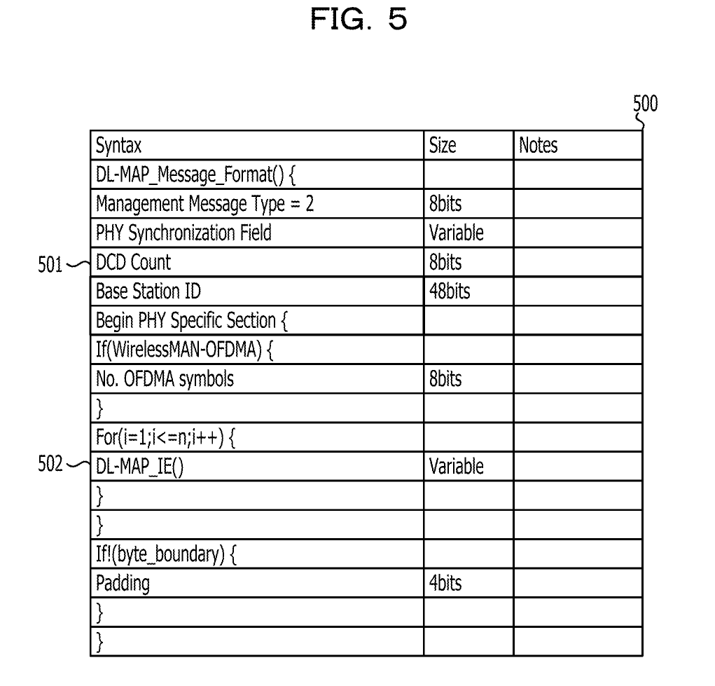

FIG. 5 is an example of a DL-MAP format. A DL-MAP 500 illustrated in FIG. 5 is the format of a DL-MAP message continuously transmitted by the base station 120. The “DCD count” indicated by the reference symbol 501 is a DCD count value indicating a version number of the DCD message currently received from the base station 120. A “DL-MAP_IE” indicated by the reference symbol 502 includes a BCCP_IE that indicates the next DCD message transmission timing.

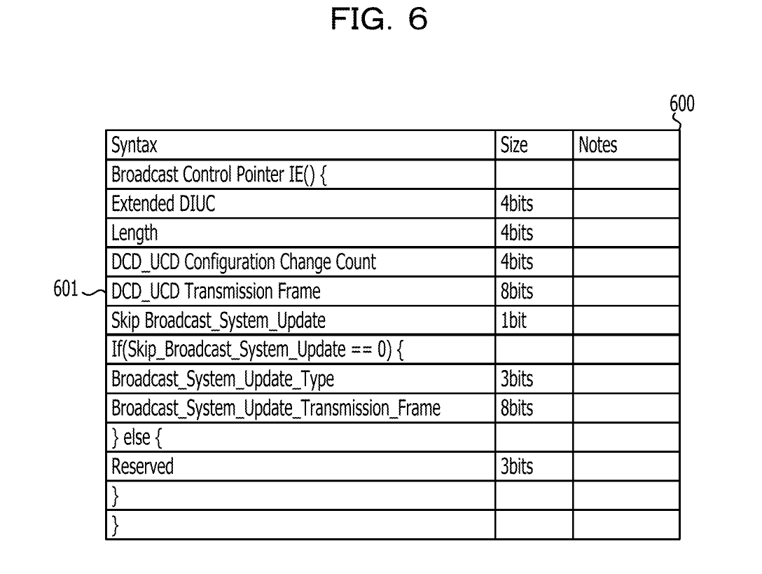

FIG. 6 is an example of a BCCP_IE format. A BCCP_IE 600 illustrated in FIG. 6 represents an example of the format of the BCCP_IE illustrated in FIG. 5. A “DCD_UCD Transmission Frame” illustrated in FIG. 6 is a frame number that indicates the next transmission timing for the DCD message.

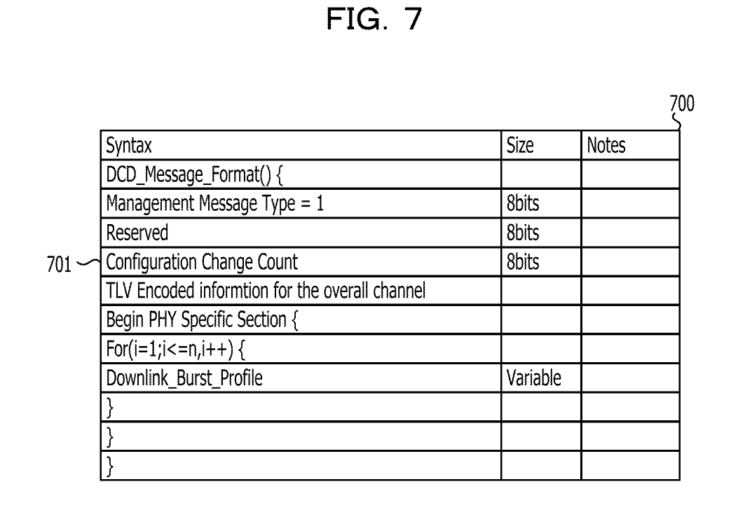

FIG. 7 is an example of a DCD message format. A DCD message 700 illustrated in FIG. 7 is the format of a DCD message transmitted periodically by the base station 120. A “Configuration Change Count” illustrated in FIG. 7 is a version number (CCC) currently being used in the communication between the base station 120 and the mobile station 110. The “Configuration Change Count” changes according to the contents of the communication parameter.

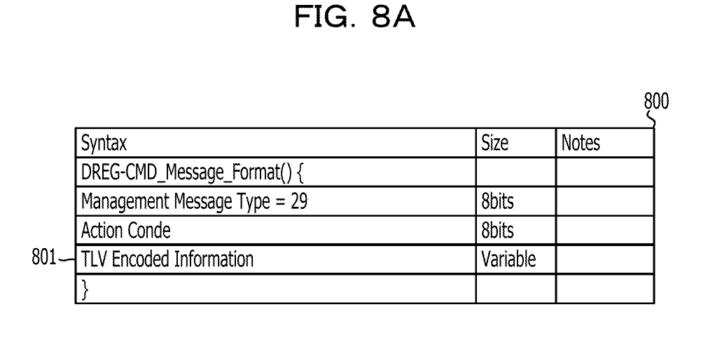

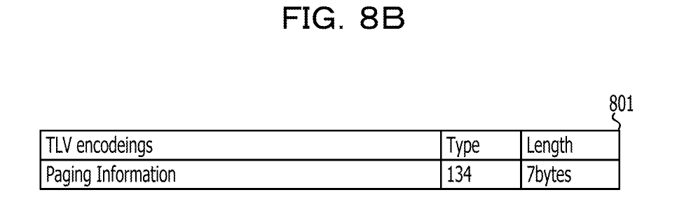

FIG. 8A is an example of a DREG-CMD message format. FIG. 8B is an example of a TLV Encoded Information format. When, for example, the mobile station 110 connects to the base station 120, the base station 120 transmits a DREG-CMD message that includes a parameter for setting the paging to the mobile station 110. The mobile station 110 stores the received DREG-CMD message in the memory 220.

A DREG-CMD message 800 illustrated in FIG. 8A is a format of a DREG-CMD message transmitted by the base station 120. “TLV Encoded Information” indicated by the reference symbol 801 includes a parameter for setting the paging. As illustrated in FIG. 8B, the “TLV Encoded Information” includes “Paging Information” that indicates a parameter for setting the paging.

The “Paging Information” includes “PAGING_CYCLE,” “PAGING_OFFSET,” and “Paging Interval Length.” The “PAGING_CYCLE” uses 0 to 15 bits to indicate a cycle in which the base station 120 conducts paging.

The “PAGING_OFFSET” uses 16 to 23 bits to indicate an offset from the frame number “0” until the paging starts. The “Paging Interval Length” indicates a period (number of frames) for maintaining the mobile station 110 in the awake state for paging.

The mobile station 110 is able to calculate the timing (frame number) when the base station 120 will conduct the next paging. For example, the timing in which the base station 120 conducts paging may be calculated from the parameters of the intermittent operation previously adjusted by the mobile station 110 and the base station 120.

For example, it is assumed that the parameters are: “PAGING_CYCLE” is 1000; “PAGING_OFFSET” is 100; and “Paging Interval Length” is 5. In this case, the timings in which the base station 120 conducts paging are “1100,” “2100,” “3100,” and so on. The mobile station 110 switches to the awake state at the transmission timings “1100,” “2100,” “3100,” and so on, and then returns to the sleep state five frames after each of the switches to the awake state.

Action by the Mobile Station

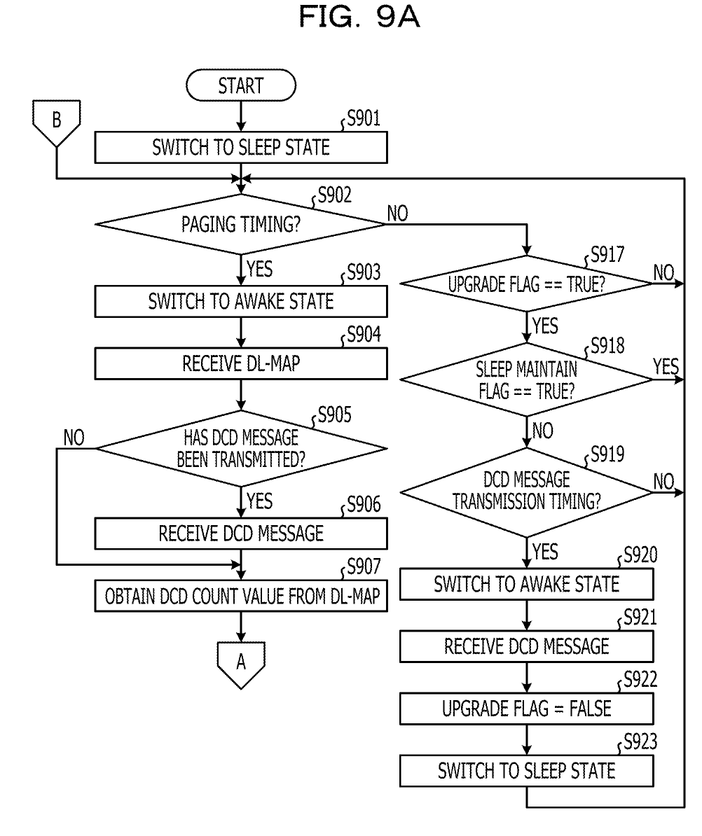

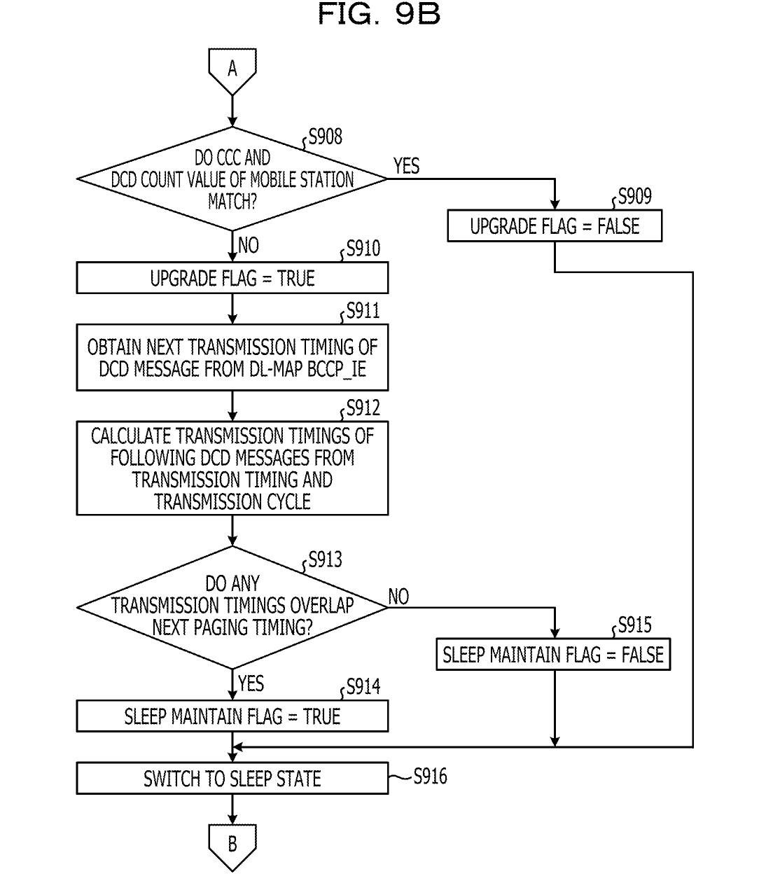

FIG. 9A is a first flow chart illustrating an example of operations by the mobile station according to the first embodiment. FIG. 9B is a second flow chart illustrating an example of operations by the mobile station according to the first embodiment.

The mobile station 110 according to the first embodiment executes, for example, the following process. First as illustrated in FIG. 9A, the controller 115 causes the communication section 111 to switch to the sleep state (step S901). If the communication section 111 is already in the sleep state at step S901, the controller 115 causes the communication section 111 to maintain the sleep state.

The controller 115 then determines whether the current timing has become a timing for paging by the base station 120 (step S902). If the current timing is a paging timing (step S902: Yes), the controller 115 causes the communication section 111 to switch to the awake state (step S903). The communication section 111 receives the DL-MAP transmitted from the base station 120 (step S904).

The communication section 111 then determines whether a DCD message has been transmitted by the base station 120 (step S905). If no DCD message has been transmitted (step S905: No), the processing of the mobile station 110 moves to step S907. If the DCD message has been transmitted (step S905: Yes), the communication section 111 receives the transmitted DCD message (step S906).

The detecting section 112 then obtains a DCD count value from the DL-MAP received in step S904 (step S907). The processing of the mobile station 110 then moves to step S908 in FIG. 9B (reference symbol A). Specifically, the detecting section 112 determines whether the CCC which the mobile station 110 possesses matches the DCD count value obtained in step S907 (step S908). As a result, the detecting section 112 may determine whether the DCD message has been updated.

If the CCC and the DCD count value are determined to match in step S908 (step S908: Yes), the controller 115 sets an update flag to “false” (step S909) and the processing moves to step S916. The update flag is information that is stored in the memory 220 of the mobile station 110 and is a flag that indicates that the DCD message has been updated.

If the CCC and the DCD count value do not match in step S908 (step S908: No), the controller 115 sets an update flag to “true” (step S910). The obtaining section 113 then obtains the next transmission timing for the DCD message from the BCCP_IE of the DL-MAP (step S911).

The obtaining section 113 calculates the subsequent transmission timings of the DCD messages based on the transmission timing obtained in step S911 and on the transmission cycle of the DCD messages (step S912). The judging section 114 determines whether the transmission timings calculated in step S912 overlap any of the timings of the next paging (step S913). For example, the judging section 114 determines whether any of the transmission timings are included within a certain period of timing from the timing of the next paging.

If it is determined that a transmission timing overlaps the timing of the next paging in step S913 (step S913: Yes), the controller 115 sets a sleep maintain flag to “true” (step S914) and the processing moves to step S916. The sleep maintain flag is information that is stored in the memory 220 of the mobile station 110 and is a flag that indicates that the sleep state is to be maintained even if there is a timing when a DCD message is transmitted.

If it is determined that none of the transmission timings overlap a timing of the next paging in step S913 (step S913: No), the controller 115 sets the sleep maintain flag to “false” (step S915). The controller 115 causes the communication section 111 to switch to the sleep state (step S916), and the processing returns to step S902 illustrated in FIG. 9A (reference symbol B).

As illustrated in FIG. 9A, if the current timing is not a paging timing in step S902 (step S902: No), the controller 115 determines whether the update flag is “true” (step S917). If the update flag is not “true” (step S917: No), the processing of the mobile station 110 moves to step S902. As a result, the sleep state may be maintained when the DCD message has not been updated.

If the update flag is “true” in step S917 (step S917: Yes), the controller 115 determines whether the sleep maintain flag is “true” (step S918). If the sleep maintain flag is “true” (step S918: Yes), the mobile station 110 processing returns to step S902. As a result, the sleep state may be maintained when the DCD message may be received at the next paging.

If the sleep maintain flag is not “true” in step S918 (step S918: No), the controller 115 determines whether the current timing is a timing for DCD message transmission (step S919). The DCD message transmission timings are the transmission timings calculated in step S912. If the current timing is not a DCD message transmission timing (step S919: No), the mobile station 110 returns to step S902.

If the current timing is a DCD message transmission timing (step S919: Yes), the controller 115 causes the communication section 111 to switch to the awake state (step S920). The communication section 111 then receives the DCD message from the base station 120 (step S921). The controller 115 then sets the update flag to “false” (step S922). The controller 115 then causes the communication section 111 to switch to the sleep state (step S923), and the processing returns to step S902.

According to the abovementioned process, if able to receive a DCD message at the next paging, the sleep state may be maintained even when a DCD message update is detected in step S908.

Thus, with the mobile station 110 according to the first embodiment, if the DCD message is able to be received even when a communication parameter update is detected, the sleep state may be maintained until the next paging. As a result, the length of timing of the awake state may be shortened and power consumption may be reduced.

### Second Embodiment

The amount of power consumption that increases when a mobile station is caused to switch to the awake state during a period in the sleep state may be derived not only by using the difference of the power consumption between the sleep state and the awake state, but also by adding an overhead portion that accompanies changes in the states. Overhead is produced, for example, by the timing taken to synchronize physical layers.

For example, when an awake state only lasts for six frames between sleep state periods, repeatedly entering an awake state six timings for a single frame consumes more power than entering an awake state once for six frames.

When the DCD message transmission timing arrives just before the call timing, the mobile station 110 according to the second embodiment reduces the number of timings to enter the awake state by receiving a DCD message at the call timing. The following is an explanation of portions of the second embodiment that are different from those of the first embodiment.

Overhead when Switching to Awake State

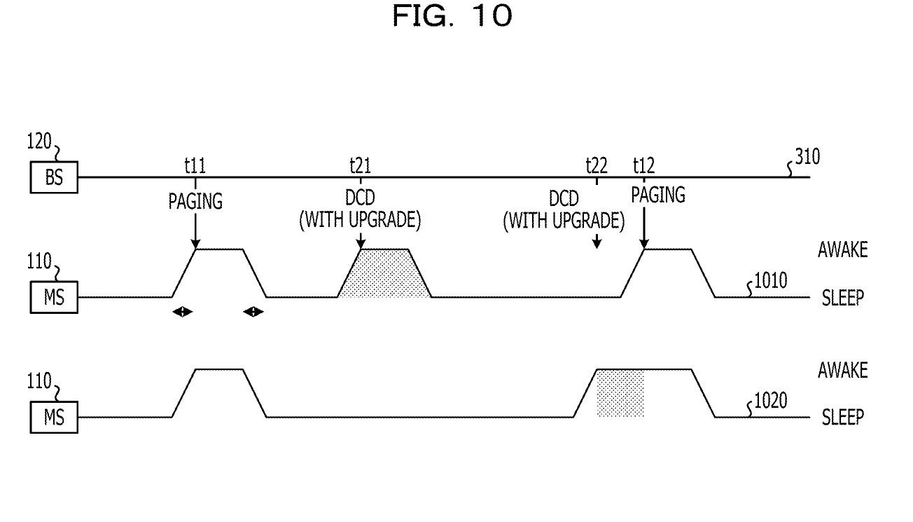

FIG. 10 illustrates an example of overhead when switching to an awake state. In FIG. 10, portions similar to those illustrated in FIG. 3 are denoted by the same reference symbols and the description thereof is omitted. In FIG. 10, the base station 120 conducts paging at timings t11, t12, and so on, and transmits the DCD messages at transmission timings t21, t22, and so on. It is assumed that the DCD message has been updated is detected due to the paging at the timing t11.

A terminal state 1010 represents a state of the mobile station 110 according to the first embodiment as reference. An overhead 1011 is the overhead upon switching from the sleep state to the awake state. An overhead 1012 is the overhead upon switching from the awake state to the sleep state.

Because the DCD message transmission timings t21, t22 and so on do not overlap the next paging timing t12, the mobile station 110 according to the first embodiment enters the awake state at the transmission timing t21 and receives the DCD message. The mobile station 110 also enters the awake state at the paging timing t12.

A terminal state 1020 depicts a state of the mobile station 110 according to the second embodiment. The mobile station 110 according to the second embodiment maintains the sleep state until the transmission timing t22 since the difference (lag width) between timing t12 and the transmission timing t22 immediately before the next paging timing t12 is small.

The mobile station 110 then enters the awake state for a period of timing from the transmission timing t22 until the timing t12. Thus, receiving the DCD message and the paging may be conducted in one awake state. As a result, power consumption due to the overhead of switching to the awake state may be lower in comparison to switching to the awake state twice.

DCD Message Receiving Operation

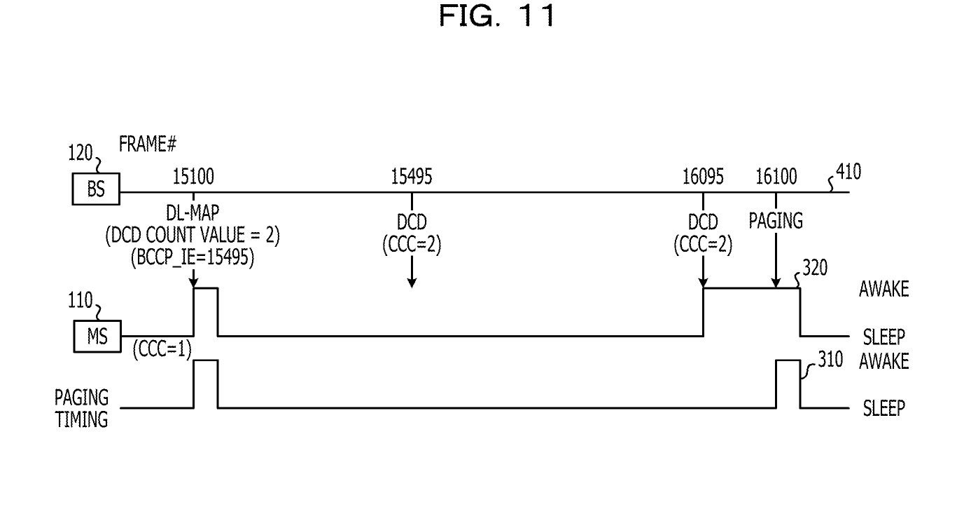

FIG. 11 illustrates a DCD message reception operation according to the second embodiment. In FIG. 11, portions similar to those illustrated in FIG. 4 are denoted by the same reference symbols and the description thereof is omitted. As illustrated by a DCD transmission timing 410, the base station 120 transmits the DCD messages in cycles of 600 frames at timings “15495,” 16095,” and so on. As illustrated by the paging timing 310, the base station 120 conducts paging in cycles of 1000 frames at timings “15100,” 16100,” and so on.

A DL-MAP received by the mobile station 110 at the paging timing “15100” includes a BCCP_IE that is set to 15495. The mobile station 110 stores the transmission cycle (herein, a 600-frame cycle) of the DCD messages transmitted by the base station 120. The mobile station 110 calculates subsequent DCD message transmission timings “15495,” “16095,” and so on based on the BCCP_IE being set to 15495 and on the 600-frame transmission cycle of the DCD messages.

In this case, the difference between the next paging timing “16100” and the DCD message transmission timing “16095” immediately before the paging timing “16100” is a mere 5 frames. Below, it is assumed, for example, that the overhead portion for power consumption that increases when a period that may be the sleep state becomes the awake state is 500 [mW], and the difference in power consumption between the sleep state and the awake state per one frame is 80 [mW].

In this case, the increase of the power consumption due to entering the awake state five frames before the call timing “16100” is 400 [mW] (80×5=400). As a result, the power consumption may be reduced more by entering the awake state five frames earlier than the call timing “16100” to receive the DCD message than by entering the awake state at the transmission timing “15945” to receive the DCD message.

The mobile station 110 maintains the sleep state until the transmission timing “16095.” The mobile station 110 is in the awake state for a period of timing from the transmission timing “16095” until a certain timing (for example, 5 frames) after the timing “16100.”

Operation by the Mobile Station

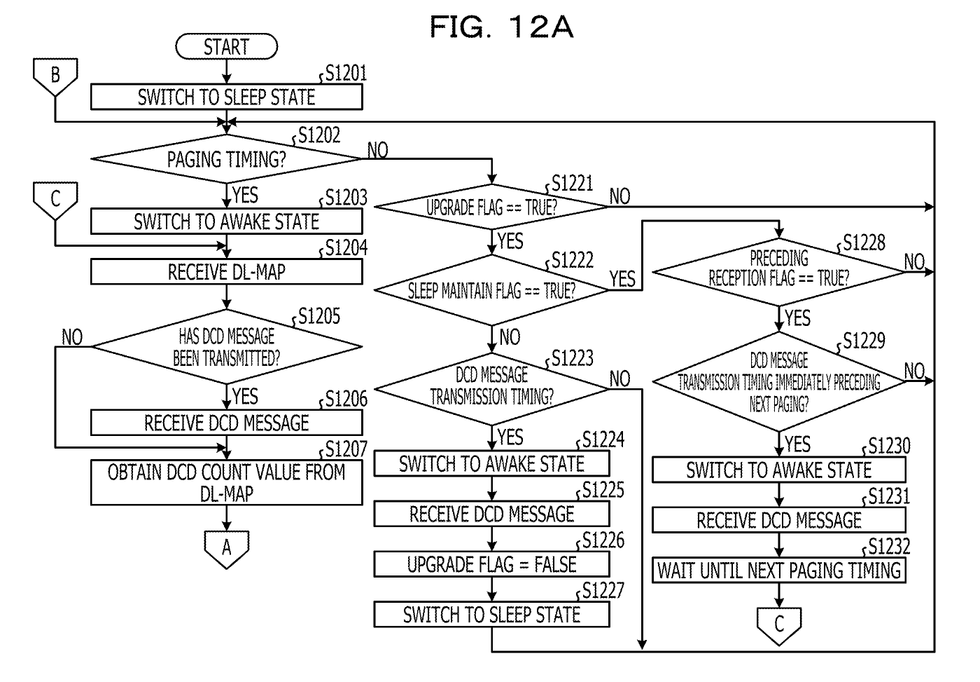

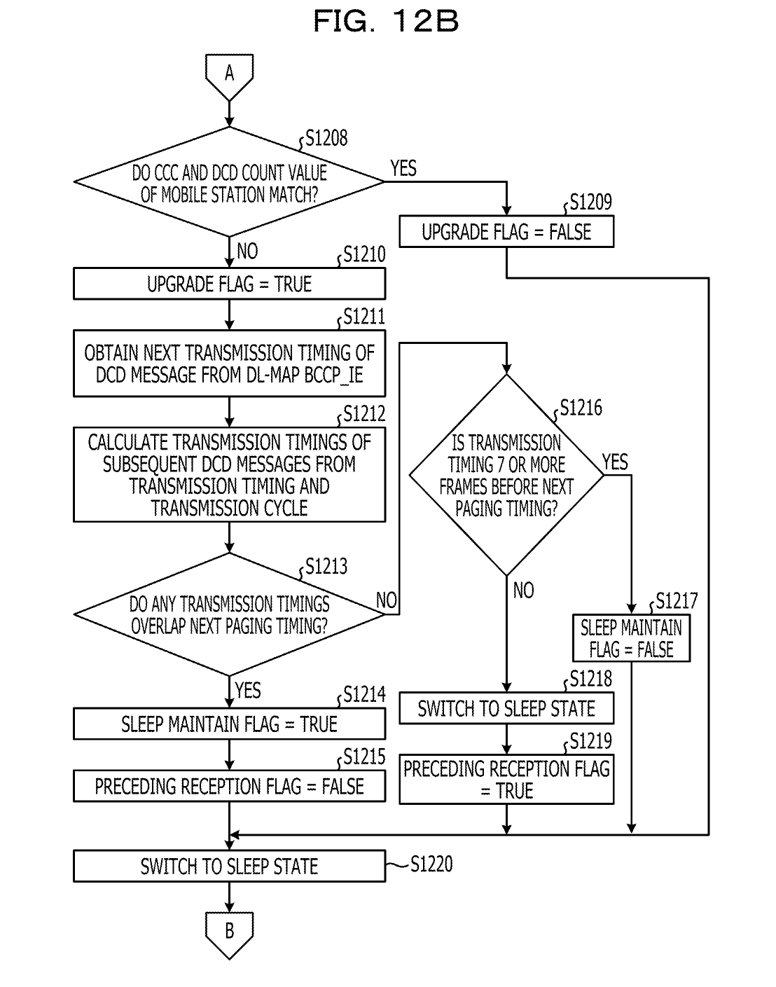

FIG. 12A is a first flow chart illustrating operations by the mobile station according to the second embodiment. FIG. 12B is a second flow chart illustrating operations by the mobile station according to the second embodiment. The mobile station 110 according to the second embodiment executes, for example, the following process.

Steps S1201 to S1214 in FIGS. 12A and 12B are similar to the steps S901 to S914 described in FIGS. 9A and 9B, and description thereof is omitted or shortened. However, after step S1209, which is similar to step S909, the processing of the mobile station 110 moves to step S1220.

Following step S1214, the controller 115 sets a preceding reception flag to “false” (step S1215), and then the processing moves to step S1220. The preceding reception flag is information that is stored in the memory 220 of the mobile station 110 and is a flag that indicates whether to switch to the awake state at the DCD message transmission timing immediately preceding the next paging.

If, in step S1213, the next paging timing does not overlap any of the transmission timings (step S1213: No), the processing of the mobile station 110 moves to step S1216. Specifically, the judging section 114 judges whether the DCD message transmission timing immediately preceding the next paging is seven or more frames before the next paging timing (step S1216). As a result, the judging section 114 is able to judge whether the difference between the next paging timing and the transmission timing immediately preceding the next paging timing is smaller than a certain value (seven frames).

If, in step S1216, the judging section 114 judges that the DCD message transmission timing immediately preceding the next paging is seven or more frames before the next paging timing (step S1216: Yes), the controller 115 sets the sleep maintain flag to “false” (step S1217), and the processing moves to step S1220. If the judging section 114 judges that the DCD message transmission timing immediately preceding the next paging is not seven or more frames earlier than the next paging timing (step S1216: No), the controller 115 sets the sleep maintain flag to “true” (step S1218). The controller 115 then sets the preceding reception flag to “true” (step S1219), and then the processing moves to step S1220. The controller 115 then causes the communication section 111 to switch to the sleep state (step S1220), and the processing returns to step S1202 (reference symbol B).

The steps S1221 to S1227 described in FIG. 12A are similar to the steps S917 to S923 described in FIG. 9A, and description thereof is omitted or shortened. If, in step S1222, the sleep maintain flag is “true” (step S1222: Yes), the controller 115 determines whether the preceding reception flag is “true” (step S1228).

If, in step S1228, the preceding reception flag is not “true” (step S1228: No), the processing of the mobile station 110 moves to step S1202. If the preceding reception flag is “true” (step S1228: Yes), the controller 115 determines whether there is a DCD message transmission timing immediately preceding the next paging (step S1229). If there is no DCD message transmission timing immediately preceding the next paging (step S1229: No), the processing of the mobile station 110 returns to step S1202.

If there is a DCD message transmission timing immediately preceding the next paging (step S1229: Yes), the controller 115 causes the communication section 111 to switch to the awake state (step S1230). The communication section 111 then receives the DCD message transmitted from the base station 120 (step S1231). The mobile station 110 then waits until the next paging timing (step S1232), and the processing moves to step S1204 (reference symbol C).

As a result of the above process, when the difference between the next paging timing and the transmission timing immediately preceding the next paging timing is smaller than a certain value, the sleep state may be maintained until the DCD message transmission timing immediately before the next paging. Then the mobile station 10 may switch to the awake state at the DCD message transmission timing immediately before the next paging.

In this way, an effect similar to the mobile station 110 according to the first embodiment may be achieved with the mobile station 110 according to the second embodiment. Even when the communication parameters are not received at the next paging timing, when the difference between the next paging timing and the transmission timing preceding the next paging timing is small, the sleep state may be maintained until the transmission timing preceding the next paging timing. As a result, the number of timings that the awake state is entered is reduced and thus power consumption may be further reduced.

### Third Embodiment

The mobile station 110 according to a third embodiment reduces the number of timings that the awake state is entered by, when the DCD message transmission timing is just after the call timing, receiving a DCD message in conjunction with the call timing. The following is an explanation of portions of the third embodiment that are different from those of the first embodiment.

DCD Message Receiving Operation

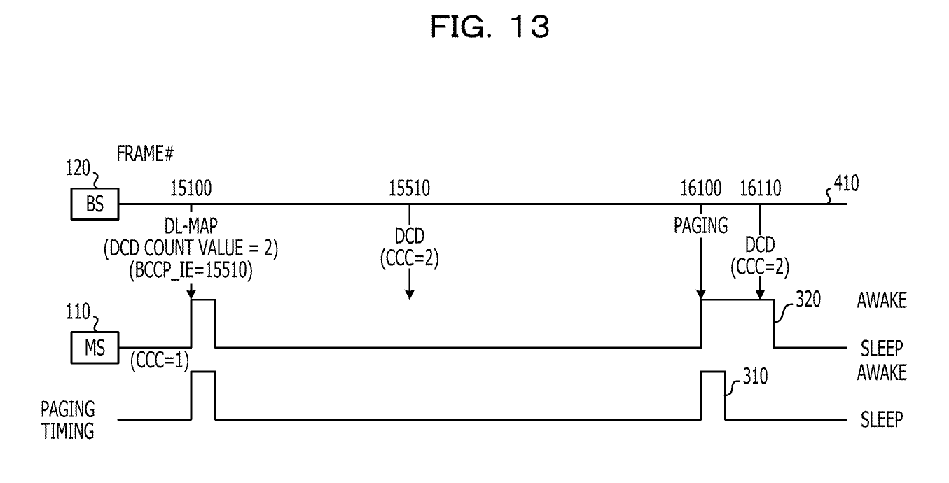

FIG. 13 illustrates an example of a DCD message reception operation according to the third embodiment. In FIG. 13, portions similar to those illustrated in FIG. 11 are denoted by the same reference symbols and the description thereof is omitted.

As illustrated by the DCD transmission timing 410, the base station 120 transmits the DCD messages in cycles of 600 frames at timings “15510,” 16110,” and so on. As illustrated by the paging timing 310, the base station 120 conducts paging in cycles of 1000 frames at timings “15100,” 16100,” and so on.

A DL-MAP received by the mobile station 110 at the paging timing “15100” includes a BCCP_IE set to 15510. The mobile station 110 stores, in the memory 220, the transmission cycle (a 600-frame cycle) of the DCD messages transmitted by the base station 120. The mobile station 110 calculates subsequent DCD message transmission timings “15510,” “16110” and so on based on the BCCP_IE being equal to 15510 and on the 600-frame transmission cycle of the DCD messages.

If the Paging Interval Length is set to 5, the end of the awake state becomes the timing “16105.” In this case, the difference between the next paging timing “16100” and the DCD message transmission timing “16110” immediately after the paging timing “16100” is a mere five frames. As a result, the mobile station 110 maintains the sleep state until the timing “16100.” The mobile station 110 is in the awake state for a period of timing from the transmission timing “16100” until a certain timing (for example, five frames) after the transmission timing “16110.”

Operations by the Mobile Station

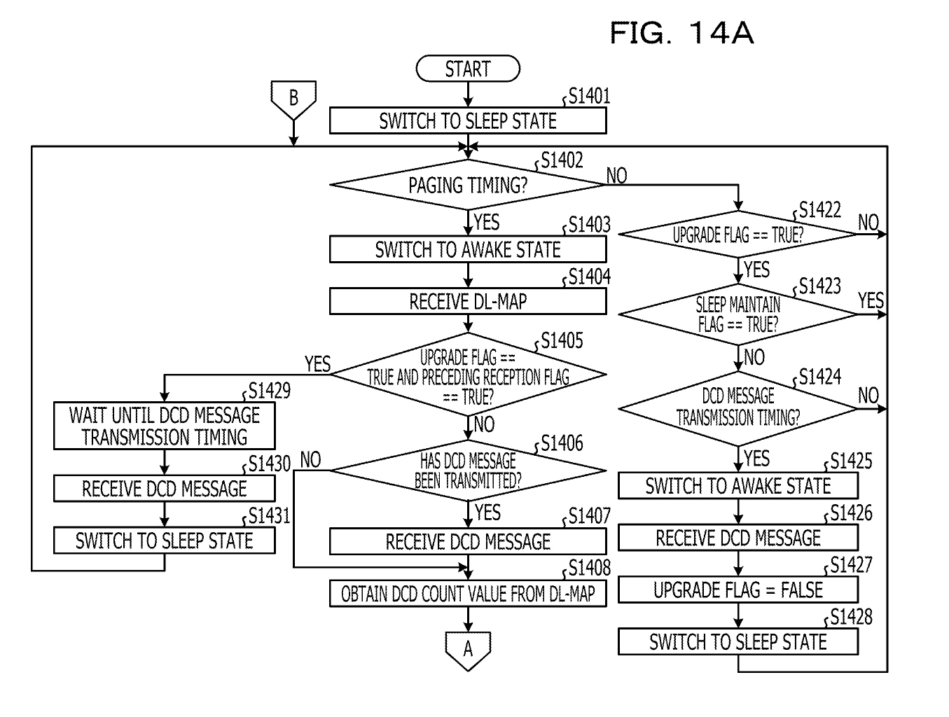

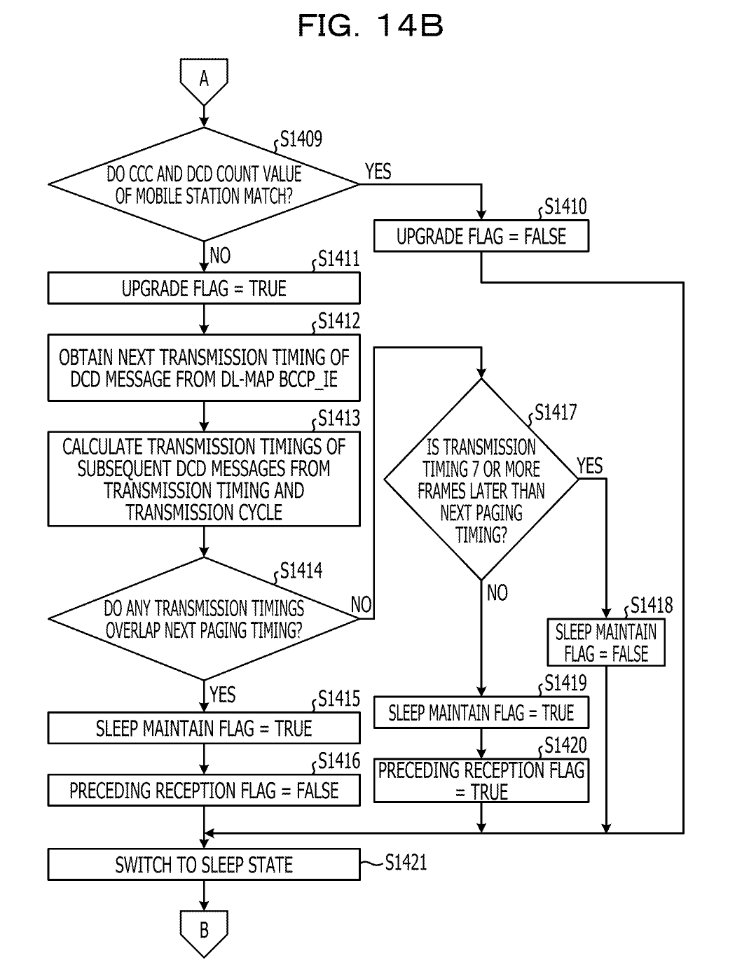

FIG. 14A is a first flow chart illustrating an example of operations by the mobile station according to the third embodiment. FIG. 14B is a second flow chart illustrating an example of operations by the mobile station according to the third embodiment. The mobile station 110 according to the third embodiment executes, for example, the following process.

Steps S1401 to S1404 in FIG. 14A are similar to the steps S901 to S904 described in FIG. 9A, and description thereof is omitted. After step S1404, the controller 115 determines whether the update flag is “true” and whether a subsequent reception flag is “true” (step S1405). The subsequent reception flag is described below. If neither the update flag nor the subsequent reception flag are “true” (step S1405: No), the processing of the mobile station 110 moves to step S1406.

Steps S1406 to S1415 in FIGS. 14A and 14B are similar to the steps S905 to S914 described in FIGS. 9A and 9B, and description thereof is omitted. After step S1415, the controller 115 sets the subsequent reception flag to “false” (step S1416). The subsequent reception flag is information that is stored in the memory 220 of the mobile station 110 and is a flag that indicates whether to maintain the awake state until the DCD message transmission timing immediately after the next paging.

In step S1414, if the next paging timing does not overlap any transmission timing (step S1414: No), the processing of the mobile station 110 moves to step S1417. Specifically, the controller 115 determines whether the transmission timing immediately after the next paging is seven or more frames later than the next paging timing (step S1417). As a result, the controller 115 is able to judge whether the difference between the next paging timing and the transmission timing immediately after the next paging timing is smaller than a certain value (seven frames).

In step S1417, if the controller 115 judges that the DCD message transmission timing immediately after the next paging is seven or more frames later than the next paging timing (step S1417: Yes), the controller 115 sets the sleep maintain flag to “false” (step S1418), and the processing moves to step S1421. If the controller 115 judges that the DCD message transmission timing immediately after the next paging is not seven or more frames later than the next paging timing (step S1417: No), the controller 115 sets the sleep maintain flag to “true” (step S1419). Next, the controller 115 sets the subsequent reception flag to “true” (step S1420), and the processing moves to step S1421. The controller 115 then causes the communication section 111 to switch to the sleep state (step S1421), and the processing returns to step S1402 (reference symbol B).

The steps S1422 to S1428 described in FIG. 14A are similar to the steps S917 to S923 described in FIG. 9A, and description thereof is omitted. If, in step S1405, the update flag and the subsequent reception flag are both “true” (step S1405: Yes), the communication section 111 waits until the DCD message transmission timing (step S1429).

The communication section 111 then receives the DCD message from the base station 120 (step S1430). The controller 115 then causes the communication section 111 to switch to the sleep state (step S1431), and the processing returns to step S1402.

As a result of the above process, when the difference between the next paging timing and the transmission timing immediately after the next paging timing is smaller than a certain value, the sleep state may be maintained until the next paging. The mobile station 10 may switch to the awake state at the next paging timing.

In this way, an effect similar to the mobile station 110 according to the first embodiment may be achieved with the mobile station 110 according to the third embodiment. Even when the communication parameter is not able to be received at the next paging timing, when the difference between the next paging timing and the transmission timing immediately after the next paging timing is small, the sleep state may be maintained until the next paging timing. As a result, the number of timings that the awake state is entered is reduced and thus power consumption may be further reduced.

The second and third embodiments may be combined. For example, the mobile station 110 may receive the DCD message with the next paging when the DCD message arrives just before the next paging and/or when the DCD message arrives just after the next paging.

### Fourth Embodiment

The first to third embodiments provided explanations of configurations to judge whether the communication parameter may be received in the next paging. The fourth embodiment provides an explanation of a configuration to judge whether the communication parameter may be received in the Mth paging. The following is an explanation of portions of the fourth embodiment that are different from the first embodiment.

DCD Message Reception Operation According to Fourth Embodiment

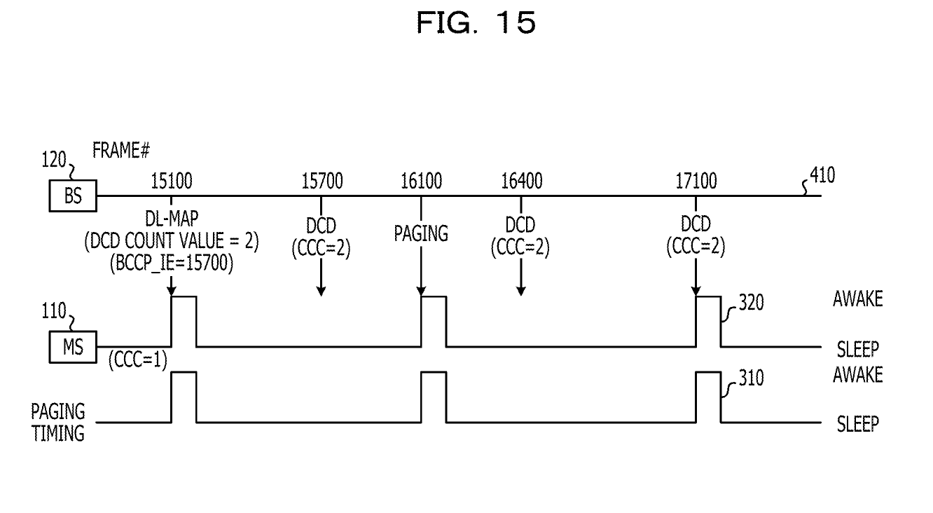

FIG. 15 illustrates an example of a DCD message reception operation according to the fourth embodiment. In FIG. 15, portions similar to those illustrated in FIG. 4 are denoted by the same reference symbols and the description thereof is omitted. As illustrated by the DCD transmission timing 410, the base station 120 transmits DCD messages in cycles of 700 frames at timings “15700,” “16400,” “17100,” and so on. As illustrated by the paging timing 310, the base station 120 conducts paging in cycles of 1000 frames at timings “15100,” 16100,” “17100,” and so on.

A DL-MAP received by the mobile station 110 at the timing “15100” includes a BCCP_IE set to 15700. The mobile station 110 stores, in the memory 220, the transmission cycle (a 700-frame cycle) of the DCD messages transmitted by the base station 120. The mobile station 110 calculates subsequent DCD message transmission timings “15700,” “16400,” “17100,” and so on based on the BCCP_IE set to 15700 and on the 700-frame transmission cycle of the DCD messages.

In this case, the next paging timing “16100” does not overlap with a DCD message transmission timing. In this case, the first paging timing “17100” after the next paging timing overlaps the DCD message transmission timing “17100.” As a result, the mobile station 110 maintains the communication section 111 in the sleep state until the paging timing “17100” except for the next paging timing “16100.” As a result, the DCD message may be received at the paging timing “17100” without switching to the awake state at transmission timings “15700” and “16400.”

Operation by the Mobile Station

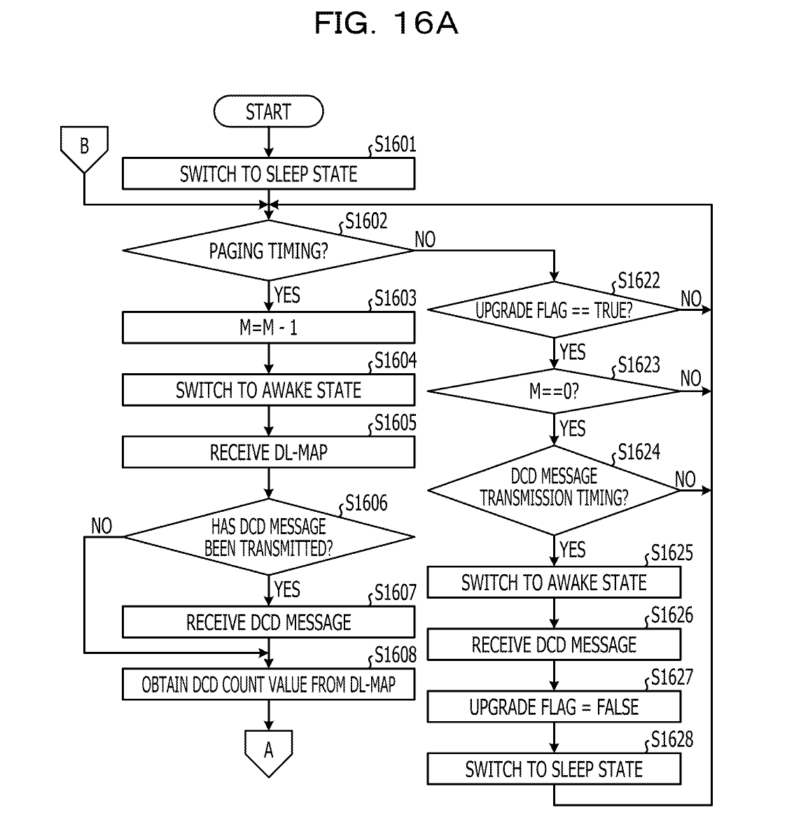

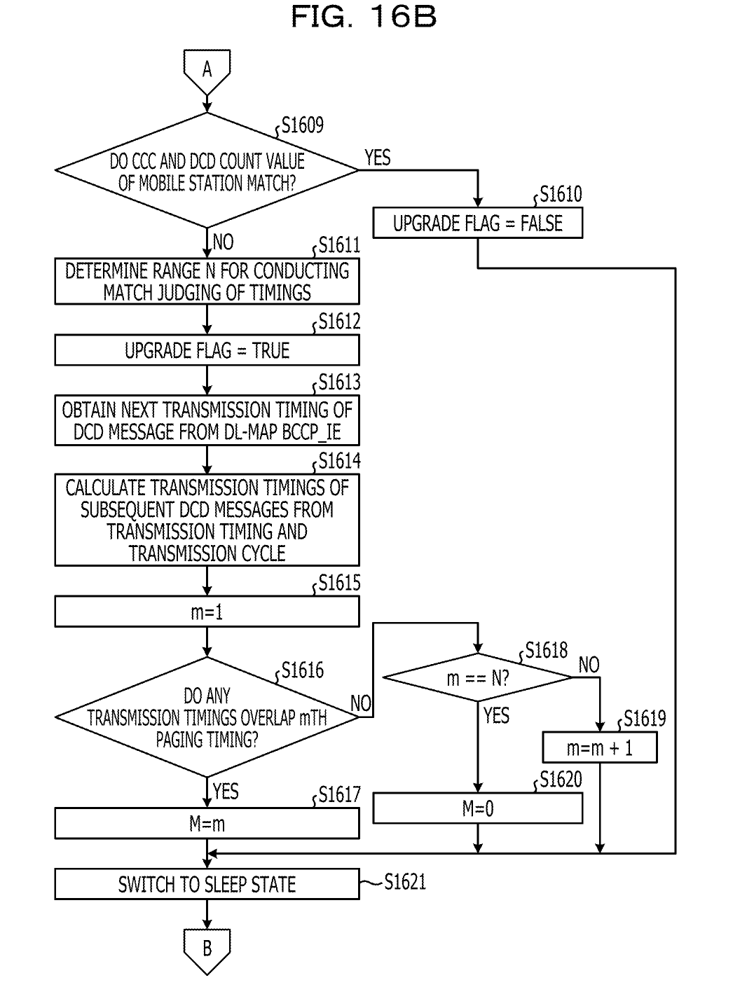

FIG. 16A is a first flow chart illustrating an example of operations by the mobile station according to the fourth embodiment. FIG. 16B is a second flow chart illustrating an example of operations by the mobile station according to the fourth embodiment. The mobile station 110 according to the fourth embodiment executes, for example, the following process.

The steps S1601 and S1602 described in FIG. 16A are similar to the steps S901 and S902 described in FIG. 9A, and description thereof is omitted. If the timing is a paging timing in step S1602 (step S1602: No), the controller 115 subtracts “1” from M (step S1603). “M” is described below. Steps S1604 to S1610 in FIGS. 16A and 16B are similar to the steps S903 to S908 described in FIGS. 9A and 9B, and description thereof is omitted.

If the CCC and the DCD count value are determined to not match in step S1609 (step S1609: No), the controller 115 determines an upper limit N of a range in which to conduct match judging of the timings (step S1611). A method to determine the upper limit N is described below. The upper limit N may be previously determined in consideration of characteristics and the like desired for the communication system 100. The upper limit N may be stored in the memory 220 of the mobile station 110.

The steps S1612 to S1614 described in FIG. 16B are similar to the steps S910 to S912 described in FIG. 9B, and description thereof is omitted. After step S1614, the judging section 114 sets “m” to 1 (step S1615). “m” is a value that indicates a timing of the paging that is subject to judging. The judging section 114 determines whether any of the transmission timings calculated in step S1614 overlap the mth timing (step S1616).

If it is determined that at least one of the transmission timings overlaps the timing of the mth paging in step S1616 (step S1616: Yes), the controller 115 sets “M” to “m” (step S1617) and the processing moves to step S1621. “M” is information that is stored in the memory 220 of the mobile station 110, and is a value that indicates that the sleep state is to be maintained from the current point in timing until the Mth paging except for each paging timing. “M” equals “0” indicates that, when the DCD message is updated, the state is to be switched to the awake state at the next DCD message transmission timing (similar to the abovementioned sleep maintain flag==“false”).

If it is determined that none of the transmission timings overlap the mth paging timing in step S1616 (step S1616: No), the controller 115 determines whether “m” has reached “N” (step S1618). If “m” has not reached “N” (step S1618: No), the controller 115 adds “1” to “m” (step S1619), and the processing moves to step S1621. If it is determined that “m” has reached “N” in step S1618 (step S1618: Yes), the controller 115 sets “M” to “0” (step S1620) and the processing moves to step S1621. The controller 115 then causes the communication section 111 to switch to the sleep state (step S1621), and the flow returns to step S1602 illustrated in FIG. 16A (reference symbol B).

As illustrated in step S1602 in FIG. 16A, if the timing is not a paging timing (step S1602: No), the controller 115 determines whether the update flag is “true” (step S1622). If the update flag is not “true” (step S1622: No), the processing of the mobile station 110 returns to step S1602.

If, in step S1622, the update flag is “true” (step S1622: Yes), the controller 115 determines whether “M” is “0” (step S1623). If “M” is not “0” (step S1623: No), the processing of the mobile station 110 returns to step S1602. As a result, the communication section 111 may maintain the sleep state until the Mth paging set in step S1617 except for each paging timing.

If, in step S1623, “M” is “0” (step S1623: yes), the processing of the mobile station 110 moves to step S1624. The steps S1624 to S1628 described in FIG. 16A are similar to the steps S919 to S923 described in FIG. 9A, and description thereof is omitted.

According to the abovementioned process, even when the DCD message is not received at the next paging, when the DCD message is able to be received at the even later Mth paging, the sleep state may be maintained except for timings for paging.

A method to determine the upper limit N as used in step S1611 will be explained. For example, the judging section 114 determines the upper limit N according to the length of a period of timing in which data communication is not being conducted by the communication section 111. Specifically, information for the association (for example, a table or a function) between the upper limit N and the length of the period of timing in which data communication is not being conducted by the communication section 111, are stored in a memory of the mobile station 110. The association information may be such that, for example, as the period in which the communication section 111 does not conduct data communication grows longer, the upper limit N becomes correspondingly larger.

As a result, the upper limit N of the range becomes smaller as the period in which the communication section 111 does not conduct data communication becomes shorter. There is a high possibility communication may be conducted immediately after a period of data communication when periods in which the communication section 111 does not conduct data communication are short. As a result, switching to the awake state is inhibited until the Mth paging and thus power consumption may be reduced, and the effect of not receiving a DCD message until the Mth paging may be reduced.

In this way, an effect similar to the mobile station 110 according to the first embodiment may be achieved with the mobile station 110 according to the fourth embodiment. Moreover, the sleep state may be maintained except for timings for paging when the communication parameter is able to be received after a certain number of pagings even if the communication parameter is not received at the next paging. As a result, the length of timing of the awake state may be shortened and power consumption may be reduced.

The effect of not receiving a DCD message until after a certain number of pagings may be reduced by causing the upper limit of the certain number of timings to be changed according to the lengths of periods of timing in which the communication section 111 consecutively did not receive data communication in the past.

As described above, power consumption may be reduced due to the mobile station, the control method, and the communication system according to the above embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile station comprising:
a communication section that enters an active state at call timings for calls from a base station, receives a communication parameter transmitted at transmission timings from the base station, and uses the received communication parameter to conduct data communication with the base station;
a judging section that judges, when an update of the communication parameter is detected, whether the communication parameter is able to be received in the active state at a next call timing for a next call from the base station based on the transmission timings; and
a controller that, when the judging section judges that the communication parameter is able to be received, causes the communication section to enter an idle state until the next call timing.

2. The mobile station according to claim 1, further comprising:
a detecting section that detects the update of the communication parameter transmitted from the base station; and
an obtaining section that obtains the transmission timings for the transmission of the communication parameter from the base station.

3. The mobile station according to claim 2, wherein
the communication section receives, when the communication section is in the active state at a call timing for a call from the base station, version number information indicating a version number of the communication parameter transmitted from the base station, and
the detecting section detects the update of the communication parameter transmitted from the base station based on the version number information received by the communication section.

4. The mobile station according to claim 2, wherein
the communication section receives, when the communication section is in the active state at the call timing, timing information indicating a next transmission timing of the communication parameter to be transmitted from the base station, and
the obtaining section obtains the transmission timings through a calculation based on the timing information received by the communication section and a transmission cycle of the communication parameter transmitted from the base station.

5. The mobile station according to claim 4, wherein
the communication section is in the active state until receiving a communication parameter consecutively a plurality of times before the update of the communication parameter is detected, and
the obtaining section obtains the transmission cycle of the communication parameter through calculation based on each of timings in which the communication section receives the communication parameter consecutively the plurality of times.

6. The mobile station according to claim 1, wherein the controller causes, when the judging section judges that the communication parameter is not able to be received, the communication section to enter the active state at a next transmission timing of the communication parameter transmitted from the base station.

7. The mobile station according to claim 1, wherein
the judging section judges, when the communication parameter is not able to be received at the next call timing in a period in which the communication section is in the active state, whether a difference between the next call timing and a preceding transmission timing that precedes the next call timing is smaller than a certain value, and
the controller causes, when the judging section judges that the difference is smaller than the certain value, the communication section to enter the idle state until the preceding transmission timing.

8. The mobile station according to claim 7, wherein the controller causes the communication section to enter the active state in a period from the preceding transmission timing to the next call timing, when the judging section judges that the difference is smaller than the certain value.

9. The mobile station according to claim 1, wherein
the judging section judges, when the communication parameter is not able to be received at the next call timing in a period in which the communication section is in the active state, whether a difference between the next call timing and a transmission timing subsequent to the next call timing is smaller than a certain value, and
the controller causes the communication section to enter the idle state until the next call timing when the judging section judges that the difference is smaller than the certain value.

10. The mobile station according to claim 9, wherein the controller causes the communication section to enter the active state in a period from the next call timing to the transmission timing subsequent to the next call timing, when the judging section judges that the difference is smaller than the certain value.

11. The mobile station according to claim 1, wherein
the judging section judges, when the communication parameter is not able to be received at the next call timing in a period in which the communication section is in the active state, whether the communication parameter is able to be received by the communication section in a period when the communication section is in the active state at a call timing after a certain number of calls from the base station after the next call timing, and
the controller causes the communication section to enter the idle state until the call timing after the certain number of calls, except for each call timing, when the judging section judges that the communication parameter is able to be received in a period in which the communication section is in the active state at the call timing after the certain number of calls from the base station.

12. The mobile station according to claim 11, wherein the judging section causes an upper limit of the certain number of calls to change based on a length of a period in which the data communication is not conducted consecutively by the communication section in the past.

13. A control method in a mobile station comprising:
controlling to enter an active state at call timings for calls from a base station, to receive a communication parameter transmitted at transmission timings from the base station, and to use the received communication parameter to conduct data communication with the base station;
judging, when an update of the communication parameter is detected, whether the communication parameter is able to be received in the active state at a next call timing for a next call from the base station, based on the transmission timings; and
controlling to enter an idle state until the timing of the next call when the judging judges that the communication parameter is able to be received.

14. A communication system, comprising:
a base station that makes calls at call timings and transmits a communication parameter at transmission timings; and
a mobile station that includes
a communication section that enters an active state at the call timings for the calls from the base station, receives the communication parameter transmitted at the transmission timings from the base station, and uses the received communication parameter to conduct data communication with the base station,
a judging section that judges, when an update of the communication parameter is detected, whether the communication parameter is able to be received in the active state at a next call timing for a next call from the base station based on the transmission timings, and
a controller that, when the judging section judges that the communication parameter is able to be received, causes the communication section to enter an idle state until the next call timing.
